(19) United States
(12) Patent Application Publication
(10) Pub. No.: US 2025/0129628 A1
(43) Pub. Date: Apr. 24, 2025

(54) AUTOMOBILE PLANT WITH SMALL CARBON FOOTPRINT

(71) Applicant: SOFTCAR SA, Fribourg (CH)

(72) Inventors: Etienne CROZIER, La Neuveville (CH); Guillaume HEISEL, Bienne (CH); Stéphane LANDWERLIN, Le Landeron (CH); Hector QUERRY, Boudry (CH); Jean-Luc THULIEZ, Le Landeron (CH); Yannick TOURAT, Feytiat (FR)

(21) Appl. No.: 18/723,252

(22) PCT Filed: Dec. 23, 2022
(86) PCT No.: PCT/IB2022/062737

§ 371 Date: Jun. 23, 2024

(30) Foreign Application Priority Data
Dec. 24, 2021 (WO) PCT/IB2021/062291

(51) Int. Cl. E04H 5/02; B60S 5/00; B62D 29/04; B62D 65/02

(52) U.S. Cl. CPC E04H 5/02; B60S 5/00; B62D 65/02; B62D 29/04

(57) ABSTRACT

A plant (01) for manufacturing electric or hybrid vehicles, the plant (01) comprising, on one site, at least one assembly space (10) for the vehicles, in which no operation of transforming steel is carried out, thereby largely eliminating toxic emissions, the production of chemical waste, noise pollution, vibrations, dust and water consumption, with the result that the plant can be installed in the vicinity of or in residential areas.

### CORRESPONDING APPLICATION

The present application claims the priority of the earlier application No. PCT/IB2021/062291 filed 24 Dec. 2021 in the name of Softcar SA, the content of said earlier application being incorporated by reference in its entirety in the present application.

### TECHNICAL FIELD

The present invention concerns the layout of an automobile plant with a small carbon footprint intended for the production of battery-powered vehicles in which subassemblies or modules are received that have already been partially assembled. This plant notably has the particular feature of not including a metal processing line that generates noise, pollution and vibration. This plant can therefore be located near residential areas and welcome individuals seeking to purchase, rent, refurbish, repair, modify or recycle a vehicle. Said plant also includes a plurality of buildings, those with the highest risk of incidents being separated from the rest of the infrastructure for safety and cost reasons.

### PRIOR ART

Automobile assembly plants are generally huge because they contain a metal processing line several kilometers long. Said line enables paying out of sheet metal, degreasing, oiling, preliminary cutting out of parts (for example body parts) by stamping them, degreasing again, welding together, phosphate treatment, painting by cataphoresis and finally curing the paint.

Apart from the fact that the production of the steel itself and the rolling operation generate enormous quantities of CO2 all the transformation operations described hereinabove are highly polluting: 35% wastage of sheet steel during stamping, use of oils for pressing, use of heavy solvents for degreasing, use of phosphorus-containing agents for the phosphate treatment necessary in preparation for cataphoresis, consumption of water for the rinsing steps, use of enormous quantities of energy in drying/curing ovens, and emission of gases in a number of these operations. In addition to chemical waste and toxic emissions, these plants also generate considerable noise and vibration. This renders working conditions difficult.

Their size makes them very costly to build, operate and maintain. Because of their size and the nuisances they cause (noise, waste, emissions, vibration) these plants must be far away from residential areas, obliging manufacturers to transport the vehicles produced from the production center to the points of sale by additional means such as trucks or trains (whereas the vehicles manufactured could travel by their own means), thus causing additional grey energy pollution.

The metal treatment line generally rules out any modularity because the first element is the monocoque sheet metal chassis, the structure onto which all the other components are assembled. This way of mass producing cars is based on optimization of the steel, which process has been the same since 1932, and is universally spread across the entire planet.

Battery-powered vehicles necessitate the fitting of propulsion batteries, generally lithium-ion batteries. This is carried out on the assembly line, making the presence of said batteries at the heart of the plant obligatory. As these plants are generally designed for the manufacture of internal combustion engine vehicles, the batteries are fitted on the existing production lines on changing over from the production of internal combustion engine vehicles to the production of electric or hybrid vehicles. In the event of fire the inflammable electrolytes of a battery generate their own oxidizer, which cannot be extinguished. The fire runs away and rapidly becomes impossible to contain. Consequently, a fire in only one battery on the assembly line can cause considerable damage because the intensity of the flames and the column of heat at more than 800° C. rising to a height of 8 m can affect the structure of the building. The fire will last until all of the electrolyte has been consumed.

If a lithium-ion battery element of an electric car catches fire, spraying it with water merely cools everything, and does not extinguish the fire. This water used for cooling becomes highly contaminated. Its chemical load even exceeds the limiting contamination values for industrial wastewater. It is therefore imperative for this water to undergo treatment before it flows into the drainage system.

The smoke from the fire would make it obligatory for the plant to be entirely evacuated and to halt all production prior to decontamination. The soot emitted during a battery fire contains large quantities of cobalt oxide, nickel oxide and manganese oxide and it is therefore the entire site that would have to be decontaminated before restarting production.

### SUMMARY OF THE INVENTION

One object of the invention is therefore to improve the methods and processes for manufacturing vehicles and the means necessary for this purpose, such as in particular the plant.

Another object of the invention is to minimize or even to eliminate the emission of carbon during the manufacture of vehicles.

Another object of the invention is to simplify vehicle manufacturing methods and to locate the manufacturing plant closer to consumers to reduce the necessity for transportation, in particular transportation by road, of the vehicles manufactured there.

Preferably, in accordance with non-limiting principles of the invention:
1) The vehicle must preferably include at least one propulsion battery (electric, hybrid or other vehicle), it must be possible to fit batteries to the vehicles, and the batteries must be assembled in a separate building that will be sacrificed in the event of fire.
2) The vehicle must contain little grey energy. To reduce grey energy and to recover materials at end of life the plant should preferably be constructed near or in a town. To be constructed in or near a town the plant must achieve “zero” emissions and “zero” water pollution and the assembly center must imperatively be of small size. To be of small size the metal treatment line must be eliminated from the manufacturing process and replaced by another process, for example an SKD process and rotational molding as described in the present application. The method and the plant must preferably integrate services, showroom, recycling of complete bodies, retrofitting, repairs, and change of body retaining the propulsion chassis. The center must preferably be close to a railway to supply components by train and the plant must be equipped with a component delivery dock.

In accordance with the invention there have been developed a new plant architecture and a new vehicle manufacturing method based on that plant architecture enabling this simplification and reduction of emissions.

The principles of the present invention, of the new plant architecture and of the method used are described hereinafter with reference to embodiments and illustrative drawings.

In embodiments the invention relates to a plant for manufacturing electric or hybrid vehicles, said plant including on a site at least one assembly space for assembling said vehicles in which no operation of transformation of steel is carried out, thereby eliminating most toxic emissions, the production of chemical or other waste, sound pollution, vibration, odors, dust and the consumption of water so that said plant can be located near or in residential zones, for example towns.

In embodiments the plant comprises on said site at least one of the following elements: a showroom open to the public and intended for vehicle purchasing; a retrofit space intended for the renovation of ageing vehicles to give them a second life; a recycling space intended for recycling components of vehicles at end of life; an ASS (after sales service) space intended for the repair of vehicles in circulation and for changing elements of said vehicles; a battery building dedicated to the storage of and the fitting of propulsion batteries in said vehicles, said battery building being separated from the rest of said plant by one or more fire breaks.

In embodiments polymer bodies may be ground up in a recycling space of the plant.

In embodiments the plant may carry out a change of body on a vehicle in circulation in its ASS space.

In embodiments the plant may function in a semi knocked down (SKD) system in which subassemblies arrive in said plant pre-assembled and pre-inspected after which said subassemblies are assembled to one another in the assembly space to produce the finished vehicle. Assembly may be effected by bolting or some other equivalent method.

In embodiments the plant is intended for the assembly of vehicles comprising four modules: a front subframe module, a rear subframe module, a central platform chassis module and a body module. Of course, this way of constructing vehicles should not be considered as limiting on the invention and other constructions may be assembled in the plant.

In embodiments the bodies are made of polymer and produced on site in the assembly building.

In embodiments the chassis modules arrive already partially or completely assembled and are assembled in the assembly building to form the chassis.

In embodiments the battery building is a rudimentary building of small size, thus having a low cost of construction and adapted to be rapidly reconstructed or renovated at lower cost in the event of an incident.

In embodiments the plant comprises at least one space dedicated to the erection of a battery tent separated from the rest of said plant by one or more fire breaks, said battery tent being usable to carry out the operations intended to be carried out in the battery building if the latter is not in operational condition.

In embodiments the plant comprises at least one workshop building separated from the rest of said plant by one or more fire breaks and dedicated to operations of adjustment, inspection, repair, ASS, retrofit, recycling or other operations on vehicles fitted with propulsion batteries.

In embodiments the workshop building is a rudimentary building of small size, thus having a low cost of construction and adapted to be rapidly reconstructed or renovated at lower cost in the event of an incident.

In embodiments the plant comprises at least one space dedicated to the erection of a temporary shelter, such as a workshop tent, separated from the rest of said plant by one or more fire breaks, said shelter being usable to carry out the operations intended to be carried out in the workshop building if the latter is not functional.

In embodiments the invention concerns a method of manufacturing vehicles, in particular battery-powered vehicles, based on the layout of a plant as described in the present application.

In embodiments the method of manufacturing vehicles, in particular battery-powered vehicles, comprises the following steps:
modules or module parts intended to form a vehicle are manufactured in a dedicated and decentralized plant;
the modules or parts thereof are taken by non-polluting or low pollution transport means to a centralized assembly plant near customers;
elements of the vehicle are produced in the assembly plant;
modules, parts of modules and elements of the vehicle are assembled in dedicated parts of the assembly plant, some dedicated parts of the plant being intended to be sacrificed if necessary and replaced by equivalent and temporary or non-temporary parts in order to prevent halting or reducing production;
in the same assembly plant there are provided parts dedicated to sales, repairs, replacement, maintenance, retrofitting, dismantling, recycling, and recovery of modules or parts of modules of existing vehicles or complete vehicles.

### BRIEF DESCRIPTION OF THE DRAWINGS

The present invention and its advantages will become more clearly apparent in the description of embodiments given hereinafter by way of non-limiting examples and with reference to the appended drawings, in which:

FIG. 1 represents a plan view of the plant,

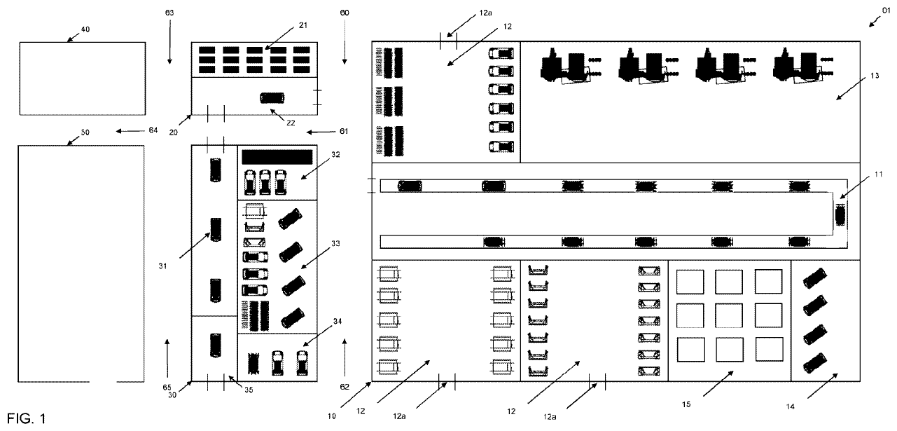

FIG. 2 represents an exploded view of an example of a vehicle that can be assembled in the plant.

### REFERENCE NUMBERS OF COMPONENTS

01: plant
10: assembly building
11: assembly line
12: component store
12a: component delivery dock
13: manufacture of parts
14: showroom
15: administrative areas
20: battery building
21: propulsion battery storage
22: propulsion battery mounting
30: workshop building
31: inspection and adjustment space
32: recycling space
33: retrofit space
34: ASS space
35: area including chargers
40: battery tent
50: workshop tent
60: fire break
61: fire break
62: fire break
63: fire break
64: fire break
65: fire break
70: vehicle
71: front subframe module
72: rear subframe module
73: central platform chassis module
74: body module

### DETAILED DESCRIPTION OF EMBODIMENTS OF THE INVENTION

The invention is not limited to the embodiments described here but can be modified by using means equivalent to those described. Thus the invention and the principle thereof concern both a plant architecture and a method of manufacturing vehicles, in particular electric vehicles but possibly hybrid vehicles (electricity with gas/gasoline/diesel/hydrogen, etc.).

Referring to the figures, the plant 01 includes an assembly building 10 in which are carried out most of the operations of assembling a battery-powered vehicle (electric, hybrid or other vehicle including at least one propulsion battery), a battery building 20 in which propulsion batteries are stored and said batteries are mounted in the vehicle, and a workshop building 30 where various operations are carried out on the vehicle.

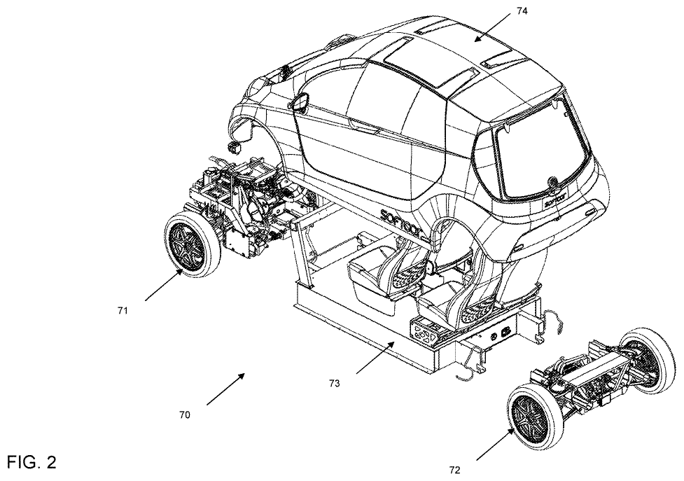

Said plant 01 as described may be used to assemble any type of battery-powered vehicle (electric or hybrid). It is particularly suitable for assembling the vehicle 70 shown in FIG. 2 by a Semi Knocked down (SKD) system/method. The SKD system/method consists in producing complete subassemblies or modules of vehicles preassembled in an external plant and then receiving said subassemblies in another plant to carry out the final assembly of the modules.

Said vehicle 70, shown by way of example in FIG. 2 to illustrate the production method of said plant 01, comprises a front subframe module 71, a rear subframe module 72, a central platform chassis module 73 and a body module 74. A vehicle of this kind is described for example in the publication WO 2017/109726. Of course, the plant in accordance with the present invention may equally be used for vehicles different from the one depicted in that publication.

In accordance with a first embodiment said chassis modules 71, 72, 73 are preferably manufactured and assembled entirely in an external plant and then shipped to said plant 01 where they are received on the component delivery dock 12a and then stored in the component store 12. In accordance with another embodiment subassemblies of said chassis modules 71, 72, 73 may be manufactured and assembled in an external plant and then shipped to said plant 01 where they are received on said component delivery dock 12a and then stored in said component store 12. Said subassemblies are then assembled in said plant 01, for example by bolting them together or by some other equivalent method, to form said chassis modules 71, 72, 73. Said chassis modules 71, 72, 73 are then moved to the assembly line 11 where they are assembled to produce a complete vehicle chassis 70. This enables optimization of the methods and places for manufacturing each module or subassembly, production of modules or subassemblies that are easily transportable (standardized shapes, optimizing storage by stacking them for example, etc.), by low-pollution means such as by rail.

In the method and the architecture in accordance with the invention the fact of not producing the parts of said chassis modules 71, 72, 73 in said plant 01 makes it possible to reduce the investment necessary for setting up the plant (fewer machines are required) and to shorten said assembly line 11 since fewer components are assembled (thus reducing the size of said plant 01 and the investment for setting it up).

In the method and the architecture in accordance with the invention only polymer parts are produced, for example parts of said body 74, by rotational molding, in said assembly building 10. This production takes place in the part manufacturing zone 13 of said plant 01. Said body 74 having large dimensions, producing it externally to ship it to said plant 01 and its transportation would cause high pollution. Parts produced locally in said plant 01 are therefore advantageously parts of large size, difficult to stack, and transportation of which would generate a high consumption of grey energy. The raw material for forming bodies for example is for its part easily transportable in sacks and/or rail cars for example and preferably delivered to said store 12.

Said body 74 being made of polymer, its production in said plant 01 does not generate noise, waste, toxic emissions or additional vibration. In contrast to a traditional body, stamping of which generates 35% waste sheet metal, here all of the material placed in the molds is used for molding said polymer parts, with no waste. Said polymer parts produced on site are mass-colored. Thus no painting operation is necessary. Once produced, the body 74 and the other polymer parts produced on site are brought to said assembly line 11 to be mounted on the chassis of said vehicle 70.

In the architecture of said plant 01 as described and in accordance with the method according to the invention no steel parts are produced or transformed. Unlike a traditional plant said plant 01 therefore includes no degreasing bath, washing bath, phosphate treatment bath, rinsing bath, hydrosoluble paint bath for cataphoresis, oven for polymerization of the paint or metal treatment line. Only a few machines for transformation of the polymer are present in said plant 01, in said part manufacturing zone 13. A result of this is a considerable reduction in the size of said plant 01, of noise and of vibration generated by production, toxic emissions, production of chemical waste such as solvents, and consumption of water in the various baths, quite apart from the risk of pollution stemming from the presence of these materials.

Working conditions in said plant 01 are more agreeable (less noise, vibration and disagreeable odors) and less harmful to health (no noxious products such as solvents). The fact of there being little noise, vibration, toxic emissions and chemical waste in said assembly building 10 of said plant 01 enables integration therein of other elements not participating directly in production such as offices, a canteen, a rest room, or other appropriate elements. Said elements could be placed in the administrative areas 15 of said assembly building 10 of said plant 01.

Said plant 01 being of small size and generating little or no pollution, it may be near residential zones in which customers are located and not isolated away from said towns, which would necessitate additional transportation of the vehicles produced to the point of sale (such as a dealership) of the vehicles concerned. This approach is all the more illogical in that the vehicles transported (in particular by truck) are in fact perfectly able to travel under their own power but must be taken from the plant to the dealership, two places that often are not in the same country.

In accordance with the method and the architecture of the invention individuals can easily go directly to the plant to choose and to purchase a new vehicle in the showroom 14, to rent a vehicle leaving the retrofit space 33, to have repair operations carried out in the ASS space 34, to deposit their vehicle at end of life in the recycling space 32, or simply to visit said assembly building 10, the environment there being clean.

In the method and the architecture in accordance with the invention said showroom 14 shows models of vehicles produced in said plant 01. Said showroom 14 receiving visitors from outside who have come to choose their future purchase, it is integrated into said assembly building 01, with fewer risks in terms of safety. The presence of said plant 01 near residential areas with an integrated showroom 14 makes it possible to reduce the number of points of sale and the pollution caused by the transportation of vehicles produced in said plant 01 to various points of sale. This principle is fundamental because it enables great reduction of the grey energy associated with the transportation of finished vehicles.

In the method and the architecture in accordance with the invention said ASS space 34 may be regarded as similar to an automobile garage. It welcomes individuals owning a model of said vehicle 70. These individuals can bring their vehicle here for various repair and/or maintenance operations and/or to change the body. Said vehicle 70 having a modular construction, said body 74 can easily be removed and replaced by another type of body or a body of different color. Said plant having all the parts constituting said vehicle 70 on site the delay time of these operations is short and the fact of not having to transport spare parts from the plant to various garages and dealerships reduces the carbon footprint of said vehicle 70.

In the method and the architecture in accordance with the invention individuals can deposit their vehicle at end of life in the recycling space 32. Vehicles at end of life are dismantled there and recycled. For example, polymer parts of said body 74 are ground up and the resulting material is taken to said part manufacturing zone 13 to be used to manufacture new body parts. The fact of reusing this ground material to produce new parts reduces the ecological impact of said parts. Other vehicle part recycling operations are equally possible. The one mentioned above is merely one non-limiting example. Parts still in a functional state can be put into said ASS space 34 or said retrofit space 33 to replace defective parts of other vehicles.

Said retrofit space 33 receives vehicles necessitating refurbishing. Obsolete, worn or defective parts are replaced there by new ones or products from said recycling space 33 in order to give the vehicles a second life and once refurbished the vehicles are offered on the secondhand vehicle market or on the short- or long-term rental market. The fact of being able to give the vehicles a second life reduces their carbon footprint.

All these processes, the architecture of the plant and the method in accordance with the invention contribute to reducing the grey energy of the vehicle and more widely to reducing its carbon footprint and that of the plant: less toxic emissions, less chemical waste, less production waste, less consumption of water for production, limited transportation of vehicles, reduced transportation of spare parts to garages and dealerships, management of the second life of the vehicles, the same basic chassis being able to receive more than one body, recycled parts at end of life, bodies produced in accordance with the circular economy principle, a point of sale integrated into the assembly center.

These modular vehicle and production elements functioning in an SKD system are described by way of example. The invention is not limited to them and could be applied to other types of vehicles and other types of production systems and methods.

In said plant 01 and the method and the architecture in accordance with the invention the distribution of workstations and operations is effected in accordance with the level of danger. In the assembly of a battery-powered vehicle the storage, charging, and manipulation of propulsion batteries represent a danger. In fact, in the event of fire the inflammable electrolytes in a battery generate their own oxidizer, which cannot be extinguished. The fire runs away and rapidly becomes impossible to contain. Consequently, fire in only one battery on the assembly line can cause considerable damage, because the intensity of the flames and the column of heat at more than 800° C. rising to a height of 8 m can affect the structure of the building.

Said assembly building 10 is the largest building of said plant 01. It represents the highest investment and requires the greatest quantity of energy and of materials to build it. In order to protect it and in accordance with the principles of the invention, no propulsion battery is stored or handled in it. The vehicles on show in said showroom 14 therefore do not include a propulsion battery and the vehicle leaving said assembly building 10 are not yet equipped with propulsion batteries.

The workstations with the greatest risk of fire are those 21 for storing batteries and those 22 for mounting batteries. In accordance with the method and the architecture of the invention these two workstations are in the battery building 20. Said battery building 20 is exclusively for these two workstations. It is therefore preferably of small size. This building 20 is also sacrificed in the event of fire.

The workshop building 30 receives vehicles leaving the battery building 20 or vehicles already in circulation. Said vehicles are therefore already equipped with propulsion batteries. In the method and the architecture in accordance with the invention, after mounting the batteries in the vehicle at said propulsion battery mounting station 22 in said battery building 20 the vehicles are moved into the inspection and adjustment space 31 of said workshop building 30 to test the seal, to adjust the geometries of the running gear, to test the geometries of the running gear, and to carry out inspection and reworking, these operations being mentioned by way of non-limiting example. The vehicles in which the batteries are fitted are charged in the area containing the chargers 35, the batteries being only partially charged when they are stored before fitting. The recycling space 32, the retrofit space 33 and the ASS space 34 receive vehicles in circulation and thus vehicles in which the propulsion battery has been installed. These workstations therefore need not be located in the assembly building 10, which must be protected from any risk associated with the batteries. The danger is nevertheless lower than for the battery storage and fitting operations. It is therefore pertinent to have another dedicated building 30. That building 30 is also sacrificed in the event of fire.

Said battery building 20 is separated from said assembly building 10 by a fire break 60. Said battery building 20 is separated from said workshop building 30 by a fire break 61. Said assembly building 10 is separated from said workshop building 30 by a fire break 62. The width of said fire breaks 60 and 61 varies as a function of the number of batteries stored in said battery building 20, that number impacting the potential range of the fire or explosion. The greater the number of batteries stored, the wider the fire break has to be. In order to prevent the propagation of flames between the buildings 10, 20 and 30 in the event of fire said fire breaks 60, 61 and 62 do not contain anything inflammable.

In accordance with one non-limiting embodiment of the architecture of the plant and of the method a path is provided in said fire break 60 in order to transfer said vehicles 70 between said assembly building 10 and said battery building 20. This path may be a road, a tunnel, a conveyor belt, a conveyor or any other element able to provide this function of transfer between said buildings 10 and 20. The above elements are mentioned by way of example.

The invention is not limited to them. They are preferably produced using only non-inflammable materials in order to prevent the propagation of flames between said battery building 20 and said assembly building 10 in the event of fire. An identical path may be installed in said fire break 61 to move said vehicles 70 between said battery building 20 and said workshop building 30.

The fire risk is low in said assembly building 10. The latter in fact contains workstations with low risk of causing fires and is separated from said buildings 20 and 30 containing the batteries. Said assembly building 10 therefore does not need to be fireproofed, which reduces its construction cost and its carbon footprint.

Said battery building 20 and workshop building 30 do not need to be fireproofed either. If a fire breaks out in one of said two buildings 20 and 30 it is not able to spread to other buildings because of said fire breaks 60, 61 and 62. Because of this they have an architecture that is not particularly fireproof and therefore a low cost of construction and a small carbon footprint.

In the event of fire in said battery building 20, in the method and the architecture in accordance with the invention the operatives in said plant 01 could allow it to be consumed and continue production activities normally carried out in said assembly building 10 and said workshop building 30 as soon as the day after the incident. Activities usually carried out in said battery building 20 could be carried out in a battery tent 40 pending decontamination, renovation and/or rebuilding of said battery building 20. Said battery tent 40 is not erected when said battery building 20 is operating normally. Nevertheless, said battery tent 40 can be erected very quickly if said battery building 20 has caught fire. A space is provided for erecting said battery tent 40, preferably from the design stage of the plant. The battery tent 40 may have any structure (rigid or non-rigid, semi-rigid, etc.) easy to erect and to take down that enables the battery zone to function in accordance with the principles of the present invention.

In the event of fire in said workshop building 30, in the method and the architecture in accordance with the invention the operatives in said plant 01 could allow it to be consumed and production activities continue normally in said assembly building 10 and battery building 20. Activities usually carried out in said workshop building 30 could be carried out in a workshop tent 50 pending decontamination, renovation and/or rebuilding of said workshop building 30. Said workshop tent 50 is not erected when said workshop building 30 is functioning normally. Nevertheless, said workshop tent 50 can be erected very quickly if said workshop building 30 catches fire. A space is provided for erecting said workshop tent 50, preferably at the design stage of the plant. The workshop tent 50 may have any structure (rigid or non-rigid, semi-rigid, etc.) easy to erect and to take down that enables the workshop to function in accordance with the principles of the present invention.

In the method and the architecture in accordance with the invention said battery building 20 is separated from said battery tent 40 by a fire break 63. Said battery tent 40 is separated from said workshop tent 50 by a fire break 64. Said workshop building 30 is separated from said workshop tent 50 by a fire break 65. The width of said fire prevention spaces 63, 64 and 65 varies as a function of a number of batteries stored in said battery building 20 and in said battery tent 40, that number having an impact on the potential range of the fire or explosion. The greater the number of batteries stored, the wider the fire break must be. In order to prevent the propagation of flames between said buildings 20 and 30 and said tents 40 and 50 in the event of fire said fire breaks 63, 64 and 65 do not contain anything inflammable.

Because of their small size and rudimentary construction, said battery building 20 and workshop building 30 could be completely rebuilt or renovated easily in the event of an incident without this causing excessive delays or costs. The loss to be made good would also be limited thanks to the use of said battery tent 40 or said workshop tent 50.

In accordance with one non-limiting embodiment of the method and of the architecture of the plant a plurality of battery buildings 20 and/or a plurality of workshop buildings 30 may be added to a single assembly building 10.

As described in detail in the present application the invention also concerns a method of manufacturing vehicles, in particular battery-powered vehicles, based on the plant layout as described hereinabove.

Generally speaking, the method may proceed as described hereinabove and also in the following manner:
modules or module parts intended to form a vehicle are manufactured in dedicated and decentralized plants;
the modules or parts thereof are taken by non-polluting or low pollution transport means into a centralized assembly plant near customers;
elements of the vehicle, such as the body for example, are produced in the assembly plant;
modules, parts of modules, elements of the vehicle are assembled in dedicated parts of the assembly plant, some dedicated parts of the plant being intended to be sacrificed in the event of problems and replaced by equivalent and temporary or non-temporary parts in order to prevent halting or reducing production;
in the same assembly plant there are provided parts dedicated to sales and/or repairs and/or replacement and/or maintenance and/or retrofitting and/or dismantling and/or recycling and/or recovery of modules or parts of modules of existing vehicles or complete vehicles.

In the method and the architecture in accordance with the invention some zones are designed from the outset to be sacrificed, for example in the event of fire or other similar event. In accordance with embodiments of the invention the parts intended to be sacrificed are in particular propulsion battery storage zones, zones for mounting propulsion batteries in the vehicles, and zones receiving vehicles already fitted with propulsion batteries.

In the method and in the architecture in accordance with the invention the bodies and body parts (doors, hood, hatch) are typically manufactured in the assembly plant either from raw materials shipped for example in powder or granule form or from recycled raw materials consisting of powders or granules produced from bodies removed from existing vehicles in the assembly plant, or from a mixture of these raw materials. This circular economy recycling principle enables bodies and body parts (doors, hood, hatch) with very low energy and emission of CO2 compared to a new body.

The embodiments of the invention, in particular of the architecture of the plant and of the method of manufacture employed, described in the present application are described by way of illustrative example and must not be considered as limiting on the invention. Other embodiments can employ means equivalent to those described, for example. The embodiments may also be combined with one another as a function of circumstances or means used in one mode can be used in another mode. The concept of the present invention is not limited to manufacture of purely electric or hybrid vehicles but could also be applied to manufacture of vehicles having another single mode of propulsion, such as internal combustion, hydrogen, gas, etc. subject to adaptation of the architecture and of the method. The principle of the invention and of the plant described could also be applied to the manufacture of other objects that give rise to the same problems and risks without being limited to automobiles as described in the present application.

1. A plant for manufacturing electric or hybrid vehicles, said plant including on a site at least one assembly space for assembling said vehicles in which no operation of transformation of steel is carried out, thereby eliminating most toxic emissions, the production of chemical or other waste, sound pollution, vibration, odors, dust and the consumption of water so that said plant can be located near or in residential zones.

2. The plant as claimed in claim 1 further including on said site at least one of the following elements: a showroom open to the public and intended for vehicle purchasing; a retrofit space intended for the renovation of ageing vehicles to give them a second life; a recycling space intended for recycling components of vehicles at end of life; an ASS space intended for the repair of vehicles in circulation and for changing elements of said vehicles; a battery building dedicated to the storage of and the fitting of propulsion batteries in said vehicles, said battery building being separated from the rest of said plant by one or more fire breaks.

3. The plant as claimed in claim 1 in which polymer bodies are ground up in its recycling space.

4. The plant as claimed in claim 1 carrying out a change of body on a vehicle in circulation in its ASS space.

5. The plant as claimed in claim 1 functioning in a semi knocked down (SKD) system in which subassemblies arrive in said plant pre-assembled and pre-inspected after which said subassemblies are assembled in the assembly space to produce the finished vehicle.

6. The plant as claimed in claim 1 intended for the assembly of vehicles comprising four modules: a front subframe module, a rear subframe module, a central platform chassis module and a body module.

7. The plant as claimed in claim 6 in which the bodies are made of polymer and produced on site in the assembly building.

8. The plant as claimed in claim 6 in which said chassis modules arrive already partially or completely assembled and are assembled in the assembly building to form the chassis.

9. The plant as claimed in claim 1 in which said battery building is a rudimentary building of small size, thus having a low cost of construction and adapted to be rapidly reconstructed or renovated at lower cost in the event of an incident.

10. The plant as claimed in claim 1 including at least one space dedicated to the erection of a battery tent separated from the rest of said plant by one or more fire breaks, said battery tent being usable to carry out the operations intended to be carried out in the battery building if the latter is not functional.

11. The plant as claimed in claim 10 including at least one workshop building separated from the rest of said plant by one or more fire breaks and dedicated to operations of adjustment, inspection, repair, ASS, retrofit, recycling or other operations on vehicles fitted with propulsion batteries.

12. The plant as claimed in claim 11 in which said workshop building is a rudimentary building of small size, thus having a low cost of construction and adapted to be rapidly reconstructed or renovated at lower cost in the event of an incident.

13. The plant as claimed in claim 11 including at least one space dedicated to the erection of a temporary shelter, such as a workshop tent, separated from the rest of said plant by one or more fire breaks, said shelter being usable to carry out the operations intended to be carried out in the workshop building if the latter is not functional.

14. A method of manufacturing vehicles, in particular battery-powered vehicles, based on the layout of a plant as described in the present application or executed by a plant as claimed in claim 1.

15. A method of manufacturing vehicles, in particular battery-powered vehicles, by the following process:
modules or module parts intended to form a vehicle are manufactured in a dedicated and decentralized plant;
the modules or parts thereof are taken by non-polluting or low pollution transport means to a centralized assembly plant near customers;
elements of the vehicle, such as the body for example, are produced in the assembly plant;
modules, parts of modules and elements of the vehicle are assembled in dedicated parts of the assembly plant, some dedicated parts of the plant being intended to be sacrificed in the event of problems and replaced by equivalent and temporary or non-temporary parts in order to prevent halting or reducing production;
in the same assembly plant there are provided parts dedicated to sales, repairs, replacement, maintenance, retrofitting, dismantling, recycling and recovery of modules or parts of modules of existing vehicles or complete vehicles.
